(19) United States
(12) Patent Application Publication
(10) Pub. No.: US 2002/0050488 A1
(43) Pub. Date: May 2, 2002

(54) Method and apparatus for thermally processing quartz using a plurality of laser beams

(76) Inventors: Dmitri Nikitin, Daytona Beach Shores, FL (US); Thomas Michel, Eustis, FL (US); Vladimire Borissovskii, Lake Mary, FL (US)

Correspondence Address: Finnegan, Henderson, Farabow,, Garrett & Dunner, L.L.P, 1300 I Street, NW, Washington, DC, 20005-3315, US

(21) Appl. No.: 09/845,910

(22) Filed: Apr. 30, 2001

Related U.S. Application Data
(63) Continuation-in-part of application No. 09/516,937, filed on Mar. 1, 2000.

(51) Int. Cl. B23K 26/32; B23K 26/06

(52) U.S. Cl. 219/121.64; 219/121.76

(57) ABSTRACT

Methods, systems, and apparatus consistent with the present invention use multiple beams of laser energy for thermally processing a quartz object. A first laser beam is generated. A second laser beam is generated that is characteristically different than first laser beam. More particularly, the first beam and second beam may have different wavelengths, energy levels, and/or focal characteristics (such as beam geometry, beam energy distribution profile, and/or focal lengths). The first and second laser beams are then provided to a combiner, which forms the beams into a composite beam. The composite beam is then applied to a portion of the quartz object where it thermally processes the quartz by selectively heating the portion of the quartz. The composite beam may also be adjusted by changing the characteristic differences between the first and second laser beams in order to alter how the composite beam selectively heats the quartz.

### RELATED APPLICATIONS

This application is a continuation-in-part of U.S. patent application Ser. No. 09/516,937 entitled METHOD APPARATUS AND ARTICLE OF MANUFACTURE FOR DETERMINING AN AMOUNT OF ENERGY NEEDED TO BRING A QUARTZ WORKPIECE TO A FUSION WELDABLE CONDITION, which was filed on Mar. 1, 2000. This application is also related to several concurrently filed and commonly owned patent applications as follows: U.S. patent application Ser. No. ______ entitled “METHOD AND APPARATUS FOR FUSION WELDING QUARTZ USING LASER ENERGY,” U.S. patent application Ser. No. ______ entitled “METHOD AND APPARATUS FOR PIERCING AND THERMALLY PROCESSING QUARTZ USING LASER ENERGY”, U.S. patent application Ser. No. ______ entitled “METHOD AND APPARATUS FOR CREATING A REFRACTIVE GRADIENT IN GLASS USING LASER ENERGY”, and U.S. patent application Ser. No. ______ entitled “METHOD AND APPARATUS FOR CONCENTRICALLY FORMING AN OPTICAL PREFORM USING LASER ENERGY.”

### BACKGROUND OF THE INVENTION

A. Field of the Invention

This invention relates to systems for thermally processing glass with laser energy and, more particularly stated, to systems and methods for using multiple beams of laser energy as a composite beam to pierce, heat or otherwise thermally process a quartz object. Each of the beams are characteristically different in that they may have different wavelengths, energy levels, and/or focal characteristics.

B. Description of the Related Art

One of the most useful industrial glass materials is quartz glass. It is used in a variety of industries: optics, semiconductors, chemicals, communications, architecture, consumer products, computers, and associated industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground, or drawn down to other usable sizes.

Many types of glasses have been “welded” or joined together with varying degrees of success. For many soft, low melting point types of glass, these attempts have been more successful than not. However, for higher temperature compounds, such as quartz, welding has been difficult. Even when welding of such higher temperature compounds is possible, the conventional processes are typically quite expensive and time-consuming due to the manual nature of such processes and the required annealing times.

When attempting to weld quartz, a critical factor is the temperature of the weldable surface at the interface of the quartz workpiece to be welded. The temperature is critical because quartz itself does not go through what is conventionally considered to be a liquid phase transition as do other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically between about 1900 to 1970 degrees Celsius (C), within which one can optimally fusion weld quartz. In other words, in that usable temperature range, the quartz object will fuse to another quartz object in that their molecules will become intermingled and become a single piece of water clear glass instead of two separate pieces with a joint. However, quartz vaporizes above that temperature range, which essentially destroys part of the quartz workpiece at the weldable surface. Thus, one of the problems in achieving an optimal quartz fusion weld is controlling how much energy is applied so that the quartz workpiece reaches a weldable condition without being vaporized.

Prior attempts to fusion weld quartz have used a hydrogen oxygen flame to apply energy to the weldable surface of the quartz workpiece. Unfortunately, most of the heat energy from the flame is lost, the heat is not uniformly applied, and a wind-tunnel effect is created that blows away sublimated quartz. Additionally, the flame is conventionally applied by hand where the welder repeatedly applies the heat and then attempts to test the plasticity of the quartz workpiece until ready for welding. This process remains problematic because it takes a very long time, wastes energy, usually introduces stresses within the weld requiring additional time for annealing, and does not avoid sublimation of the quartz workpiece.

Another possibility for heating the quartz workpiece to a fusion weldable condition is to use a temperature feedback system. However, attempts to empirically measure the temperature of the quartz workpiece as part of a feedback loop have been found to be unreliable. Physical measurements of temperature undesirably load the quartz workpiece. Those skilled in the art will appreciate that this type of physical measurement also introduces uncertainties that are characteristic with most any physical measurement but especially present in the high temperature state of quartz when near or at a fusion weldable condition.

In addition to simply welding quartz together, there is a need for a method or system that can precisely control how the energy is applied in order to heat only the areas desired to be heated and to control how deep the quartz is heated. Use of a hydrogen oxygen flame is typically done to provide a directed and somewhat controllable energy source. However, the flame remains problematic when additional precision is required.

Accordingly, there is a need for a system that can thermally process a portion of the quartz in a controlled and efficient manner.

### SUMMARY OF THE INVENTION

Methods, systems, and articles of manufacture consistent with the present invention overcome these shortcomings by using multiple laser beams to thermally process at least a portion of a quartz object. Often, these laser beams have different characteristics such that when combined into a composite beam and applied to the quartz, efficient and advantageous thermal processing of the quartz can be achieved. More particularly stated, a method consistent with the present invention, as embodied and broadly described herein, begins with applying a first of the beams of laser energy to the quartz object, the first beam having a first wavelength, energy level or focal characteristic. Such focal characteristics may include, but is not limited to, focal length, beam geometry, and energy distribution profile. Next, a second of the beams of laser energy is combined with the first beam to form a composite beam. The second beam may have a second wavelength, energy level and/or focal characteristic that is different from that of the first beam. The composite beam is then used to thermally process (e.g., selectively heat, fusion weld, etc.) the quartz object.

In another aspect of the present invention, as embodied and broadly described herein, a method for thermally processing a quartz object using multiple laser beams begins by generating a first of the beams of laser energy and then generating a second of the beams of laser energy. The second beam is characteristically different than the first beam. More particularly stated, the second beam may have a different wavelength, energy level, and/or focal characteristic than that of the first beam. These focal characteristics may include focal length, beam geometry, and energy distribution profile.

Next, the first beam and the second beam are each provided to a combiner to form a composite beam. The composite beam from the combiner is applied to a portion of the quartz object. Using the applied composite beam, the portion of the quartz object is thermally processed with the composite beam by selectively heating the portion of the quartz object using energy from the composite beam.

While being applied to the quartz, characteristics of the first beam or the second beam or both beams may be adjusted to alter how the composite beam selectively heats the portion of the quartz object. Typically, such adjustments may include altering one or more characteristics of the first beam, the second beam or both beams, such as the respective wavelength, energy level and/or focal characteristics.

In yet another aspect of the present invention, as embodied and broadly described herein, an apparatus for thermally processing a quartz object using multiple beams of laser energy, comprises a first laser, a second laser and a combiner. The first laser provides a first laser beam on an output of the first laser while the second laser provides a second laser beam on an output of the second laser. The second beam is characteristically different than the first beam. More specifically stated, the second laser beam may have a wavelength, energy level and/or focal characteristic that is different from that of the first laser beam.

The combiner is coupled to the outputs of each laser and combines the first beam and the second beam into a composite beam, which is provided to a portion of the quartz object. The combiner may be implemented with a beam expander and a reflector/combiner. The beam expander is typically coupled to the output of the first laser and is operative to delay the first beam relative to the second beam. The reflector/combiner usually receives the delayed first beam from the beam expander and receives the second beam from the output of the second laser before joining the delayed first beam with the second beam into the composite beam.

The apparatus may also include a set of lenses positioned to receive the composite beam and focus the first beam and the second beam within the composite beam. The lenses may also be adjustable to enable selective adjustment of focal lengths of the first beam and the second beam.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1, consisting of FIGS. 1A-1C, is a series of diagrams illustrating an exemplary quartz laser fusion welding system consistent with an embodiment of the present invention;

FIG. 2 is a diagram illustrating an exemplary movable welding head used to direct laser energy consistent with an embodiment of the present invention;

FIG. 3 is a functional block diagram illustrating components within the exemplary quartz laser fusion welding system consistent with an embodiment of the present invention;

FIG. 4, consisting of FIGS. 4A-4B, is a diagram illustrating a welding zone between quartz objects being laser fusion welded consistent with an embodiment of the present invention;

FIG. 5 is a diagram illustrating a laser energy source having multiple laser beams consistent with an embodiment of the present invention;

FIG. 6 is a flow chart illustrating typical steps for thermally processing a quartz object using multiple laser beams consistent with an embodiment of the present invention; and

FIG. 7, consisting of FIGS. 7A-7D, is a series of diagrams of wavefront cross-sections and energy distributions.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

In general, methods and systems consistent with the present invention apply laser energy to a quartz workpiece, such as two quartz objects, in order to bring the workpiece to a fusion weldable condition and form a fusion weld between the objects. In order to successfully weld quartz, a careful balance of thermal load at the weldable surface should be maintained in order to create the boundary conditions for the quartz to properly intermingle or fuse on a molecular level and avoid the creation of a cold joint that is improperly fused. Such a system can be used to selectively heat any internal portion of the object using such laser energy in a delicate and almost surgical manner. An improvement to such a system involves using multiple laser beams each having at least one different characteristic (e.g., wavelength, energy level, focal characteristic, etc.) to provide an optimized heating zone when applied to the quartz object.

Those skilled in the art will appreciate that use of the terms “quartz”, “quartz glass”, “vitreous quartz”, “vitrified quartz”, “vitreous silica”, and “vitrified silica” are interchangeable regarding embodiments of the present invention. Additionally, those skilled in the art will appreciate that the term “thermally process” means any type of glass processing that requires heating, such as cutting, annealing, or welding.

In more detail, when quartz transitions from its solid or “super-cooled liquid” state to the gaseous state, it evaporates or vaporizes. The temperature range between the liquid and gaseous state is somewhere between about 1900 degrees C. and 1970 degrees C. The precise transition temperature varies slightly because of trace elements in the material and environmental conditions. When heated from its solid or super-cooled state to a still super-cooled but very hot, more mobile state, the quartz becomes tacky or thixotripic. Applicants have found that quartz in this state does not cold flow much faster than at lower elevated temperatures and it does not flow (in the sense of sagging) particularly fast, but it does become very sticky.

As the temperature approaches the transition range, the thermal properties of quartz change radically. Below 1900 degrees C., the thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable state, applicants have discovered that it becomes a thermal mirror or a very reflective surface.

The quartz thermal conductivity non-linearly increases with thermal input and increasing temperature. There exists a set of variable boundary layer conditions influenced by thermal input. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once, causing abrupt vaporization of the material.

This boundary layer phenomenon is further examined and discussed below. The subsurface layers of the quartz workpiece have, to some depth, a coefficient of absorption which is fixed at “Initial Conditions” (IC) described below in Table 1.

TABLE 1

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | μ |
| Let the density be: | p |

As the quartz is heated over a temperature range below 1900 degrees C., k increases but with a shallow slope, and d remains relatively constant and fairly large. However, applicants have found that as the temperature exceeds 1900 degrees C., the slope of k increases at a third-order (cubic) rate until it becomes asymptotic with an increase in thermal conductivity. Simultaneously, the depth of sub-surface penetration d decreases similarly. This causes an increase in the thermal gradient within the quartz object that reduces the bulk thermal conductivity but increases it at the thinning boundary layer on the weldable surface of the object.

As a result, the heat energy is concentrated in the boundary layer at the weldable surface. As this concentration occurs, the coefficient of thermal conductivity increases. These dramatic, non-linear, thermal property changes in the boundary layer create a condition where the energy causes the (finite) weldable surface of the quartz object to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on applying laser energy in order to selectively pierce a quartz object, selectively heat or otherwise thermally process an inner portion of the quartz object and then fusion weld the quartz object back together.

For optimal fusion welding, it is important to determine how much heat is needed to raise the quartz object's temperature to just under the vaporization or sublimation point. As described in related U.S. patent application Ser. No. 09/516,937, the amount of energy (energy from a laser, or other heat source) that is required to heat a quartz object to its thermal balance point (thermal-equilibrium) is preferably determined prior to applying that energy to the quartz object, which is incorporated by reference. The present application focuses on using multiple laser beams to apply energy to a quartz object when thermally processing the object.

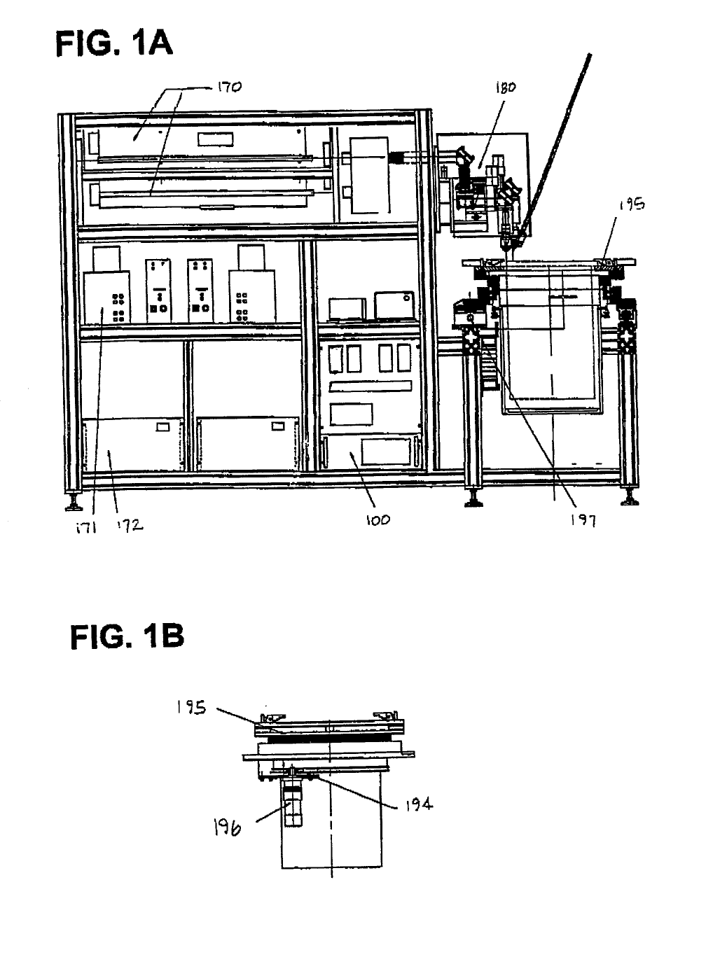

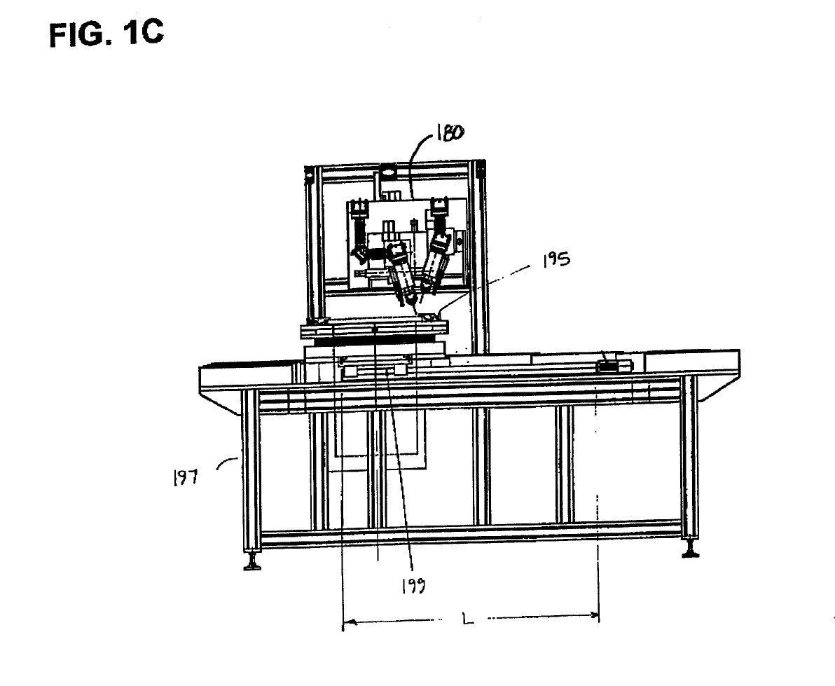

An exemplary quartz fusion welding system is illustrated in FIGS. 1A-C that is suitable for applying laser energy from multiple lasers to one or more quartz objects consistent with the present invention. FIG. 1A is the front view of such a system. FIG. 1B illustrates the system's movable working surface and FIG. 1C is a side view of the system showing another view of the movable working surface and a movable welding head.

Referring now to FIG. 1A, the exemplary quartz fusion welding system 1 includes a laser energy source 170, a movable welding head 180 (more generally referred to as a reflecting head), a working table 197 having a movable working surface 195, and a computer system 100. While the illustrated system 1 supports the workpiece using working table 197 and moveable working surface 195, another embodiment of such a system (not shown) uses a lathe-type support structure for supporting tubular workpieces that can be spun around as laser energy is applied. An embodiment of such an alternative system for supporting and moving the workpiece is described in U.S. patent application Ser. No. ______, which is commonly owned and hereby incorporated by reference.

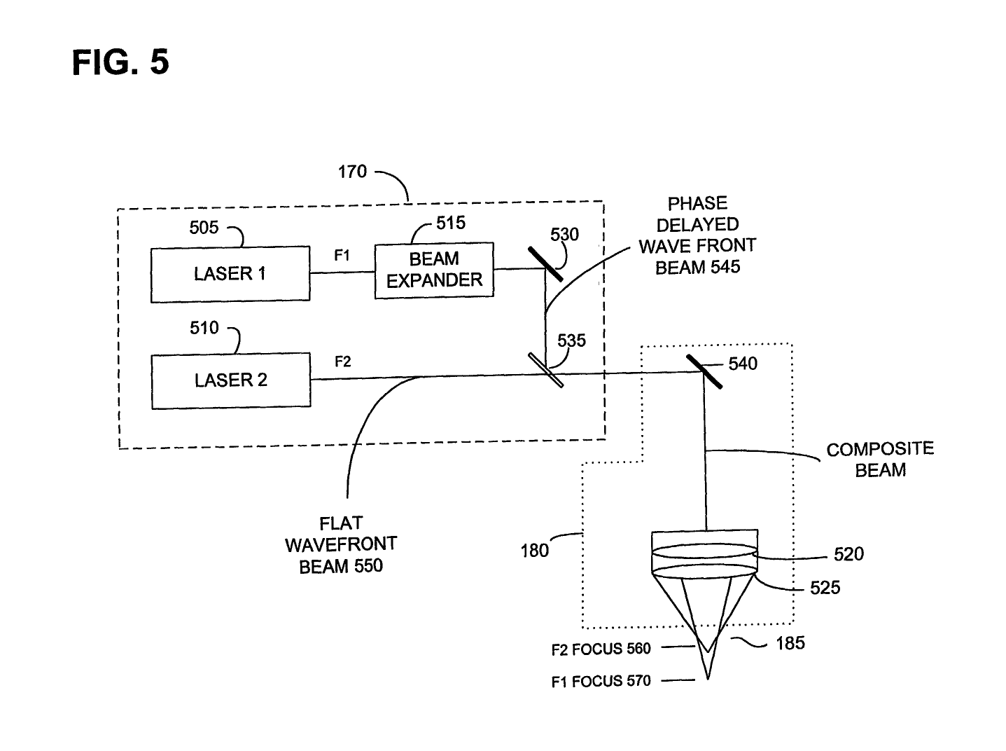

In the illustrated embodiment from FIG. 1A laser energy source 170 is powered by power supply 171 and cooled using refrigeration system 172. In the exemplary embodiment, laser energy source 170 is two sealed Trumpf Laser Model TLF 3000t CO₂ lasers having a predefined wavelength of 10.6 microns. The lasers are typically capable of providing 3000 Watts of laser power, have a focal length of 3.75 inches and a focal spot size of 0.2 mm in diameter. Those skilled in the art will appreciate that the lasers can have the same or different wavelengths, such as 355 nm or 3.5 microns, as part of a laser energy source consistent with an embodiment of the present invention. The laser energy source having multiple lasers is discussed in more detail below regarding FIG. 5. Further, those skilled in the art will appreciate that the term “laser” should be interpreted to mean a lasing element and may also include laser systems with terminal optics.

When two quartz objects (not shown) are to be thermally process (e.g., fusion welded), the objects are placed in a configuration on movable working surface 195. In general, the configuration is a desired orientation of each object relative to each other. More specifically, the configuration places a surface of one quartz object proximate to and substantially near an opposing surface of the other quartz object. These two surfaces form a gap or channel between the objects where the laser energy is to be applied. Those skilled in the art will appreciate that the configuration for any two quartz objects will vary depending upon the desired thermal processing of the objects.

After placement of the quartz objects into the configuration, laser energy source 170 provides energy in the form of a laser beam 175 to movable welding head 180 under the control of computer system 100. Movable welding head 180 receives laser beam 175 and directs its energy in a beam 185 to a welding zone between the two quartz objects in accordance with instructions from computer system 100. While it is important to apply laser energy when fusion welding two quartz objects in an embodiment of the present invention, it is desirable that the system have the ability to selectively direct how and where the laser energy is applied relative to the quartz objects themselves. To provide such an ability, the laser energy is applied in a selectable vector (an orientation and magnitude) relative to the quartz objects being thermally processed (e.g., heating or fusion welding).

Selecting or changing the vector can be accomplished by moving the laser energy relative to a fixed object or moving the object to be welded relative to a fixed source of laser energy. In the exemplary embodiment, it is typically accomplished by moving both the quartz objects being thermally processed (by moving and/or rotating the working surface 195 under control of the computer 100) and by moving the vector from which the laser energy is applied (using actuators to move angled reflection joints within movable welding head 180). In this manner, the system provides an extraordinary degree of freedom by which laser energy can be selectively applied to the quartz object(s).

FIGS. 1B and 1C are diagrams illustrating views of the exemplary working table 197. Referring now to FIG. 1B, a portion of working table 197 is shown having movable working surface 195 that is rotatable. The working surface 195 rotates in response to commands or signals from computer 100 to rotational actuator 196 (typically implemented as a DC servo actuator). A timing belt 194 connects the output of the DC motor within rotational actuator 196 to the working surface 195. Thus, working surface 195 rotates the configuration of quartz objects being welded that are supported on the working surface 195 of table 197. Furthermore, table 197 includes a linear actuator 199 to provide linear movement (also called translation) along a length (preferably considered an x-axis) of table 197 as shown in FIG. 1C. FIG. 1C illustrates a side view of table 197. The linear actuator 199 preferably moves the working surface 195 (and its rotational actuators and controls) along length L so that the quartz objects being fusion welded are moved relative to movable welding head 180. Thus, working surface 195 is movable in a linear and rotational sense to selectively position the quartz object(s) relative to the movable welding head 180.

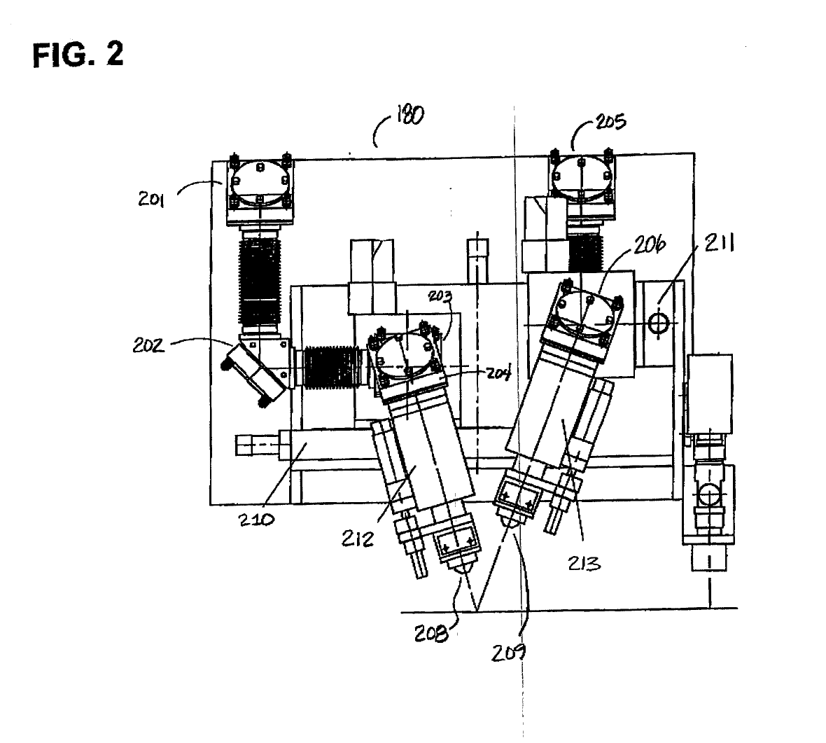

FIG. 2 is a diagram illustrating an exemplary movable welding head used to direct laser energy consistent with an embodiment of the present invention. Referring now to FIG. 2, movable welding head 180 (commonly referred to as a reflective head) is generally a conduit for directing the laser energy from laser energy source 170 to the welding zone between the quartz objects being welded. In the exemplary embodiment, movable welding head 180 (more generally called a movable head) directs laser beams using angled reflective surfaces (e.g., mirrors or other types of reflectors) within elbows of a re-configurable arrangement of angled reflection joints. Furthermore, in the exemplary embodiment and as discussed with regard to FIG. 5 where laser energy source 170 includes two lasers, the first laser projects a beam that is directed through joint 201, through joint 202, through joint 203, and finally through joint 204 before exiting welding head 180 at output 208. Similarly, the second laser projects another beam of laser energy that is directed through another series of angled reflection joints, namely joints 205, 206, and a joint not shown which is directly behind joint 206, before exiting welding head 180 at output 209. Those skilled in the art will appreciate that the alignment of the directed laser energy depends upon the orientation of each joint and its relative position to the other joints.

When using two lasers, it is further contemplated that one of them may be used as a pre-heating laser while the other is used as a welding laser. For example, one of the lasers from laser energy source 170 may provide a pre-heating laser beam through output 208 while the other laser may provide a welding laser beam through output 209.

In the exemplary embodiment, welding head 180 is movable in relation to the source of laser energy 170. This allows positioning of the welding head 180 to selectively alter where the laser energy is to be applied while using a fixed or stationary source of laser energy. In more detail, welding head 180 includes a series of actuators capable of moving the angled reflection joints relative to each other. For example, welding head 180 includes an x-axis actuator 210 and a y-axis actuator 211. These actuators permit movement of the laser beams directed out of laser outputs 208, 209 in an x- and y-direction, respectively. The z-axis actuator (not shown) is located on the back of welding head 180 and operates similar to actuators 210, 211 in that it permits movement of the laser beams directed out of laser outputs 208, 209 in a z-direction (e.g., up and down). The x-axis actuator 210, y-axis actuator 211, and z-axis actuator (not shown) are preferably implemented using an electronically controllable, crossed roller slide having a DC motor and an encoder for sensing the movement.

In the embodiment where there are two lasers as the laser energy source, welding head 180 may also include a z1-axis actuator 212 and a z2-axis actuator 213. These actuators 212, 213 move the outputs 208, 209 relative to each other and facilitate focusing the beams. The z1-axis actuator 212 and the z2-axis actuator 213 are preferably implemented as electronically controllable, linear, motorized slides. Such slides also have DC motors for positioning and encoders for sensing position and are used to selectively adjust the position of lenses (not shown) that focus the beams.

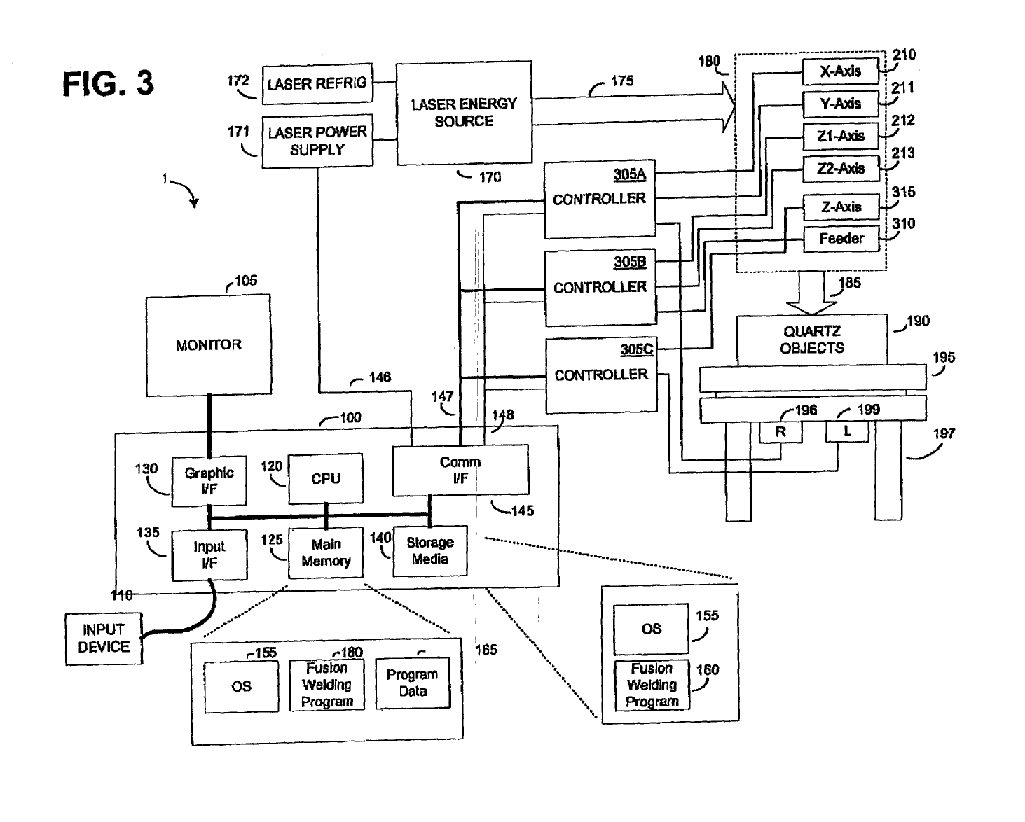

Looking at the exemplary quartz laser fusion welding system 1 in more detail, FIG. 3 is a functional block diagram illustrating components within the exemplary quartz laser fusion welding system consistent with an embodiment of the present invention. Referring now to FIG. 3, welding system 1 includes computer system 100, which sets up and controls laser energy source 170, movable welding head 180, and movable working surface 195 in a precise and coordinated manner during fusion welding of the quartz objects on working surface 195. Computer system 100 typically turns on laser energy source 170 for discrete periods of time. Computer system 100 also controls the positioning of movable welding head 180 and movable working surface 195 relative to the quartz objects being welded so that surfaces on the objects can be easily fusion welded in an automated fashion. As discussed and shown in FIGS. 1B and 1C, movable working surface 195 typically includes actuators allowing it to move along a longitudinal axis (preferably the x-axis) as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125). Computer-readable storage media 140 may be implemented as a hard disk drive that maintains files, such as operating system 155 and fusion welding program 160, in secondary storage separate from main memory 125. One skilled in the art will appreciate that other computer-readable media may include secondary storage devices (e.g., floppy disks, optical disks, and CD-ROM); a carrier wave received from a data network (such as the global Internet); or other forms of ROM or RAM.

Graphics interface 130, typically implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 1 to facilitate communication with and control over those other parts. Communication interface 145 includes a connection 146 (preferably using a conventional I/O controller card) to laser energy source 170 used to setup and control laser energy source 170. In the exemplary embodiment, this connection 146 is to laser power supply 171. Those skilled in the art will recognize other ways in which to connect computer system 100 with other parts of fusion welding system 1, such as through conventional IEEE-488 or GPIB instrumentation connections.

In the exemplary embodiment of the present invention, communication interface 145 also includes an Ethernet network interface 147 and an RS-232 interface 148 for connecting to hardware that implement control systems within movable welding head 180 and movable working surface 195. The hardware implementing such control systems includes controllers 305A, 305B, and 305C. Each controller 305A-C (typically implemented using Parker 6K4 Controllers) is controlled by computer system 100 via the RS-232 connection and the Ethernet network connection. Communication with the control system hardware through the Ethernet network interface 147 uses conventional TCP/IP protocol. Communication with the control system hardware using the RS-232 interface 148 is typically for troubleshooting and setup.

Looking at the hardware in more detail, controllers 305A-305C control the actuators that selectively apply the laser energy to a surface of a quartz object on the working surface 195 of the table 197. Specifically, controller 305A is configured to provide drive signals to x-axis actuator 210, y-axis actuator 211, and rotational (“R”) actuator 196. Controller 305B is typically configured to provide drive signals to z1-axis actuator 212, z2-axis actuator 213, and a fill rod feeder (“Feeder”) actuator 310 attached to the movable welding head 180. Similarly, controller 305C is configured to provide drive signals to the z-axis actuator 315 and linear (“L”) actuator 199 for linear movement of the working surface 195 of table 197.

Each of the drive signals are typically amplified by amplifiers (not shown) before sending the signals to control a motor (not shown) within these actuators. Each of the actuators also typically includes an encoder that provides an encoder signal that is read by controllers 305A-C.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Fusion Welding Process

In the context of the above-described system, fusion welding program 160 causes a specific amount of laser energy to be applied to the quartz objects that are in the configuration on table 197 in a controlled manner. This is typically accomplished by manipulating the movable welding head 180 and movable working surface 195. The laser energy is advantageously and uniformly applied to the object surfaces being fusion welded or, more generally, to the portions of the quartz object being thermally processed.

As part of setting up to fusion weld two quartz objects together, the quartz objects are placed in their pre-weld configuration and soaked at an initial preheating temperature to help avoid rapid changes in temperature that may induce stress cracks within the resulting fusion weld. In the exemplary embodiment, the preheating temperature is typically between 500 and 700 degrees C. and is preferably applied with a laser. Other embodiments may include no preheating or may involve applying energy for such preheating using the beam of laser energy itself or energy from other heat sources, such as a hydrogen-oxygen flame.

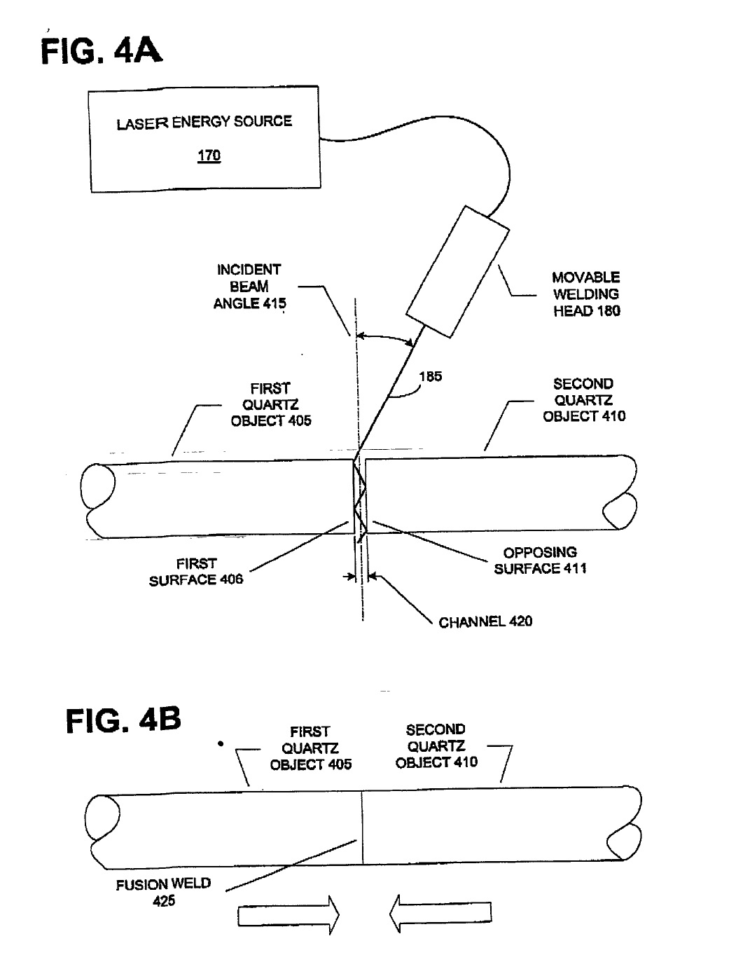

Once preheated, fusion welding program 160 determines how much energy is needed to bring the surfaces of the quartz objects to the desired fusion weldable condition without vaporizing quartz material. Quartz fusion welding system 1 then aligns the source of laser energy by positioning the movable welding head 180 to provide laser beam 185 to a welding zone between the objects being welded. FIGS. 4A and 4B are diagrams illustrating a welding zone between exemplary quartz objects being laser fusion welded consistent with an embodiment of the present invention. Referring now to FIG. 4A, a first quartz object 405 is disposed on movable working surface 195 next to a second quartz object 410 after being preheated. For clarity, the first quartz object 405 and the second quartz object 410 are illustrated as stock quartz rods that have end surfaces 406 and 411, respectively, that are to be fusion welded together. When placing the first quartz object 405 in a pre-weld configuration with the second quartz object 410 before preheating, surface 406 on the first object 405 is placed proximate to and substantially near opposing surface 411 on the second object 410. In this configuration, the end surfaces 406, 411 define a gap or channel 420 between the objects.

After preheating, laser energy source 170 generates laser energy in the form of laser beam 185 that is directed to the welding zone between the objects. Movable welding head 180 operates to align the energy and direct laser beam 185 to end surface 406 of the first object 405. This is typically accomplished by focusing the laser beam at an incident beam angle 415 of 0 to 10 degrees (this may vary depending upon the type, geometry and character of the material being processed) from the centerline of the channel. While the exemplary environment typically uses a 0 to 10 degree incident beam angle when launching laser beam 185 into channel 420, those skilled in the art will realize that different geometries of materials may require a different angle of incidence for the laser beam as it is reflected and distributed along the channel 420. For example, if the first quartz object 405 is a rod or cylindrical object that is being fusion welded to a planar second quartz object (not shown), then the incident beam angle may be from 0 to 45 degrees above the planar surface. However, under certain configurations of the material being processed, the angle may vary up to nearly 90 degrees above the planar surface.

As surface 406 absorbs the incident laser energy from laser beam 185 and the surface is increasingly heated, the surface 406 becomes shiny and reflective. In other words, as the surface 406 approaches a fusion weldable condition, the quartz surface 406 reaches a reflective state. In this reflective state, surface 406 bounces or transfers the energy of the laser beam 185 to opposing surface 411. As a result, opposing surface 411 also reaches the reflective state and laser beam 185 is repeatedly reflected down the length of channel 420 heating surfaces 406 and 411 to a substantially uniform or even distribution. This advantageously allows for precise and substantially even heating of surfaces deep within channel 420. Once the surfaces to be welded reach the reflective state and distribute the heat, the surfaces reach a fusion weldable condition so that the surfaces will molecularly fuse together to form a fusion weld.

FIG. 4B is a diagram illustrating the first object 405 after it is fusion welded to the second object 410. The reflected laser energy has heated both end surfaces to reach a fusion weldable condition and then both objects were joined together in a fusion weld 425 where the molecules from the first object 405 become intermingled with the molecules of the second object 410. Those skilled in the art will appreciate that causing the objects to join and then fuse may be due to gravity or due to an applied compressive force.

Additionally, those skilled in the art will appreciate that it is possible to use a glass fill rod to fill in channel 420 and complete the fusion weld. Essentially, the fill rod is fed into the channel as the surfaces in the channel are heated.

While fusion weld 425 is illustrated as a visible line in FIG. 4B, those skilled in the art will also appreciate that the resulting fusion welded quartz will be a singular object with no visible seam, crack or demarcation to show the weld.

In the exemplary embodiment, it is contemplated that the laser beam can be multiple laser beams, each of which having selectable characteristics such as wavelength, energy level, or focal characteristics (e.g., beam geometry, energy distribution profile, focal length, etc.). Using multiple laser beams is often useful and desired when the area to be heated is relative thick and there is a need to create a lengthy heating zone (also called a laser beam focal field). With multiple laser beams, adjusting the selectable characteristics of the laser beams can also alter how the energy is applied to the object to achieve such a lengthy or configurable heating zone.

Referring now to FIG. 5, details within laser energy source 170 and movable welding head 180 in an embodiment of the invention are further illustrated to show how multiple laser beams can be combined into a composite beam. In this example, laser energy source 170 comprises a first laser (Laser1) 505 and a second laser (Laser2) 510, each of which can be selectively turned on/off or modulated to deliver a desired amount of energy within their beams. Laser1 505 and Laser2 510 may be implemented as programmably controllable sealed CO₂ lasers that selectively provide Gaussian beam energy distribution profiles at powers of up to 3000W, and may have the same or different wavelengths, energy levels, and focal characteristics.

The beams from each laser are combined or bundled together coaxially or collaterally to form a composite laser beam. The applicants have found that it is often advantageous to combine the laser beams and produce the composite beam using different focal characteristics, different wavelengths, and/or different energy levels. These differing characteristics of the two beams produce a flexible and configurable zone of highly concentrated energy. In the example illustrated in FIG. 5, those skilled in the art will appreciate that Laser1 505 provides a laser beam F1 to a beam expander 515, which delays the phase of the F1 wave front. This creates a phase-delayed wave front 545 that is reflected off reflector 530. Combiner/reflector 535 then joins phase-delayed wave front 545 with a flat wave front beam 550 (also called the F2 wave front), which is provided by Laser2 510, to produce an integrated or composite laser beam. In this manner, laser beams F1 and F2 can be combined or bundled together as the composite beam to target specific zones on or within the quartz through their respective focal characteristics precipitating reactions from or with chemicals, dopant materials, or other species that affect the physical, chemical or optical characteristics of the quartz.

The composite laser beam may be provided to the moveable welding head, reflected through a series of one or more reflectors 540 and then provided onto lenses 520, 525. Lenses 520 and 525 are selectively adjustable via actuators (such as actuators 212, 213) or other such conventional focusing mechanisms. The ability to selectively focus lens 520 and lens 525 by moving lenses 520, 525 relative to each other and phase-delaying one of the beams help to provide the ability to create a zone of high energy concentration (also called the heating zone) between the F1 focus point 570 and the F2 focus point 560.

Additionally, if laser beam F1 and laser beam F2 are characteristically different, it has been discovered that such differences, when combined, also contribute to creating the zone of high energy concentration. Thus, one skilled in the art can appreciate that if one of the laser beams (e.g., laser beam F1) is adjusted relative to the other laser beam (e.g., laser beam F2), the adjustment causes a shift or change in the configuration of the composite beam. Such adjustments may include setting or changing the wavelength, energy level and/or focal characteristics of one or both beams to be different than each other. For purposes of this application, focal characteristic is meant to include focal point or length, beam geometry (e.g., spot size, diameter, etc.), and energy distribution profile (e.g., Gaussian distribution, etc.).

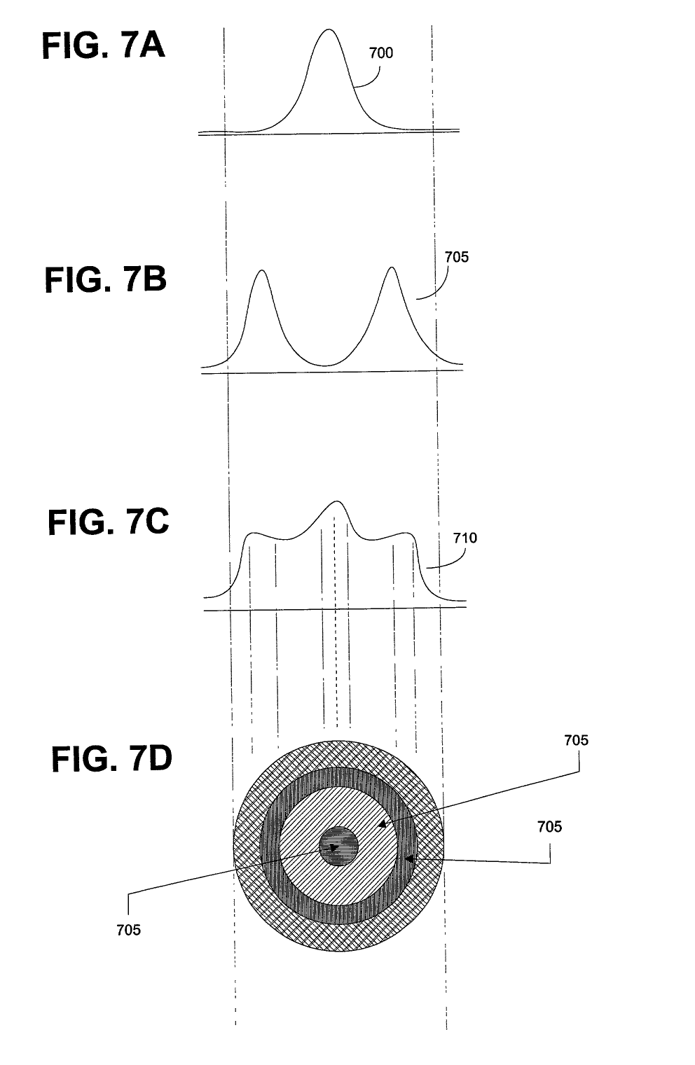

The beams may also be different in their electromagnetic modes and polarization characteristics. For example, one of the beams may have a Gaussian wavefront which is a TEM₀₀ mode, as shown in FIG. 7A as wavefront cross-section 700. The other beam may have a characteristic “donut” wavefront which is a TEM_{01*} mode, as shown in FIG. 7B as wavefront cross-section 705.

Combining these modes coaxially, the composite beam will result in a “head and shoulders” waveform as shown in FIG. 7C as combined cross-section 710. The composite beam concentrates heat in a relatively large area but instead of dissipating along a Gaussian distribution, it maintains high power density in a peripheral annulus 715 around a Gaussian peak 720 as shown in the energy distribution diagram of FIG. 7D.

For example, in one embodiment of the present invention, it may be advantageous to have laser beam F1 at 10.6 microns while laser beam F2 is set or adjusted to be 3.5 microns. Creating an energy concentration zone using such a composite beam having different wavelengths will produce a configuration of the composite beam that allows selective heating of the quartz in a manner different than with a composite beam of homogenous wavelength.

In another embodiment, laser beam F1 may be set at 300 Watts while laser beam F2 is set or adjusted to 500 Watts. With different energy levels with beams that make up the composite beam, those skilled in the art will appreciate that the energy being applied in the zone between F1 focal point 570 and F2 focal point 560 is graduated or non-uniform in nature. This graduated energy profile may be advantageous depending upon how much heat is desired to be applied at various depths within the quartz.

In yet another embodiment, it may be advantageous to have laser beam F1 at a focal length that is much greater than the focal length of laser beam F2. Again, such characteristic differences between the laser beams that make up the composite beam help to shape and alter the configuration of the composite beam and, ultimately, how the composite beam can selectively heat a portion of the quartz workpiece.

It is contemplated that setting these characteristic differences or adjusting the beams to create such differences is typically done as of an initialization procedure within laser energy source 170 (e.g., Laser1 505 and Laser2 510). However, it may be made while the laser energy source 170 is already generating a composite beam and a different type of thermal processing of the quartz is desired, such as going from simply heating the quartz to fusion welding the quartz. It is further contemplated that these adjustments may be made manually to the lasers or programmatically (e.g., via signals sent by controller 100 to laser power supply 171 or directly to the laser energy source).

In summary, the superposition of multiple foci produces a relatively lengthy and high energy focal field, which can be used to thermally process (e.g., selectively heat or fusion weld) quartz within that area as the composite beam is applied to the quartz. The ability to use multiple lasers each with different wavelengths, modes, polarizations, energy levels, and/or focal lengths provides additional flexibility to the composite beam to facilitate enhanced processing of the quartz and/or other dopant materials heated by the beam as the beam moves relative to the glass.

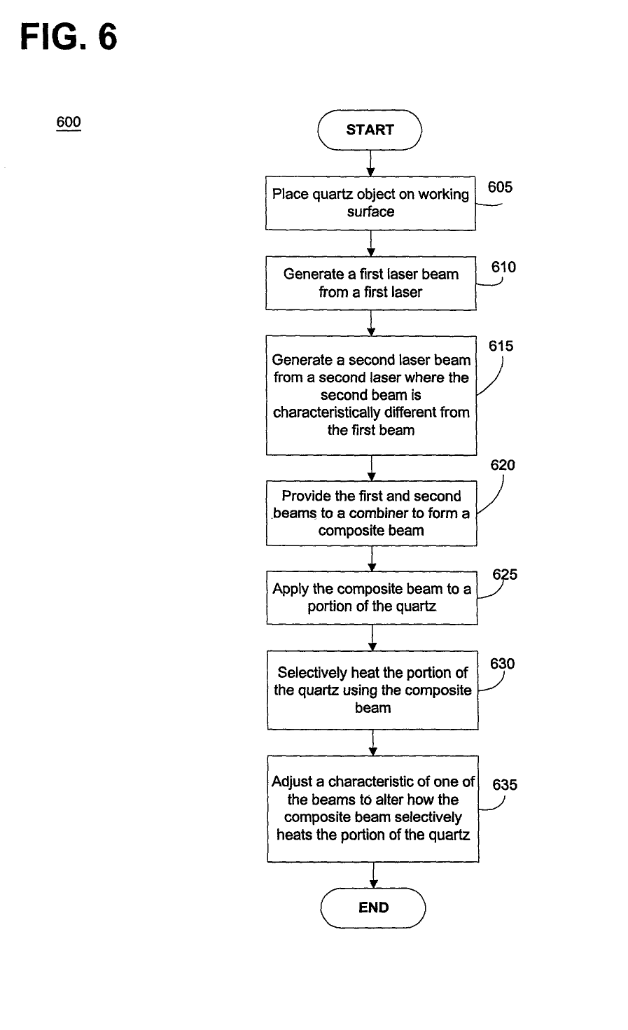

FIG. 6 is a flowchart illustrating typical steps for thermally processing a quartz object using multiple laser beams consistent with an embodiment of the present invention. Referring now to FIG. 6, method 600 begins at step 605 where the quartz object is placed on a working surface. In the exemplary embodiment, quartz object 600 is placed on working surface 195 in preparation for thermally processing the object.

The next few steps involve applying a first laser beam and combining it with a second laser beam having different characteristics than the first beam. In more detail at step 610, the first laser beam is generated from a first laser. In the exemplary embodiment, laser beam F1 is generated by Laser1 505 as part of laser energy source 170 at a wavelength of 10.6 microns. However, the second laser beam is generated from a second laser at step 615 and is characteristically different than the first laser beam. In the exemplary embodiment, laser beam F2 is generated by Laser2 510 at a wavelength of 3.5 microns, which is different than that of laser beam F1. In other embodiments, energy levels, focal characteristics and/or other parametric characteristics of the laser beams may be different.

At step 620, the first laser beam and the second laser beam are provided to a combiner to form a composite beam. In the exemplary embodiment, laser beam F1 is provided from the output of Laser1 505 to the combination of beam expander 515, reflector 530 and reflector/combiner 535, collectively implementing a combiner, while laser beam F2 is provided from the output of Laser2 510 directly to the reflector combiner. Those skilled in the art will appreciate that while the exemplary embodiment implements the combiner using these elements, the combiner may be implemented with any optical coupling devices capable of joining two distinct laser beams into a single collateral or coaxial composite beam.

At step 625, the composite beam from the combiner is applied to a portion of the quartz object. In the exemplary embodiment, the composite beam is provided as an output from reflector/combiner 535 to reflector 54, through lenses 520 and 525 and then onto a portion of the quartz workpiece positioned on the working surface.

At step 630, the applied composite beam operates to thermally process the portion of the quartz where it is applied. In one embodiment, the composite beam thermally processes the portion by selectively heating that portion of the quartz using energy from the composite beam. Selectively heating may be implemented by modulating the composite beam as a whole or by modulating or altering characteristics of each beam that makes up the composite beam. In another embodiment, the composite beam thermally processes the quartz by fusion welding portions of the quartz back together or fusion welding the portion of the quartz to another piece of quartz. In yet another embodiment, the composite beam thermally processes the quartz by using the composite beam to cut into the portion of the quartz.

At step 635, method 600 continues by adjusting one of the beams relative to the other beam within the composite beam. Adjusting in this sense is defined to mean adjusting a characteristic of the laser beam, such as wavelength, energy level, or focal characteristic. Adjusting one of the laser beams in this fashion alters how the composite beam selectively heats the portion of the quartz object.

Those skilled in the art will appreciate that embodiments consistent with the present invention may be implemented in a variety of technologies and that the foregoing description of an implementation of the invention has been presented for purposes of illustration and description. It is not exhaustive and does not limit the invention to the precise form disclosed. Modifications and variations are possible in light of the above teachings or may be acquired from practicing of the invention. While the above description encompasses one embodiment of the present invention, the scope of the invention is defined by the claims and their equivalents.

What is claimed is:

1. A method for thermal processing a quartz object using a plurality of beams of laser energy, comprising the steps of:
applying a first of the beams of laser energy to the quartz object, the first beam having a first wavelength;
combining a second of the beams of laser energy with the first beam to form a composite beam, the second beam having a second wavelength that is different from the first wavelength; and
thermally processing the quartz object with the composite beam.

2. The method of claim 1, wherein the first beam has a first energy level and the second beam has a second energy level that is different from the first energy level.

3. The method of claim 1, wherein the first beam has a first focal length and the second beam has a second focal length that is different from the first length.

4. The method of claim 1, wherein the step of thermally processing further comprises selectively heating the quartz object with the composite beam.

5. The method of claim 1, wherein the step of selectively heating further comprises fusion welding the quartz object.

6. A method for thermal processing a quartz object using a plurality of beams of laser energy, comprising the steps of:
applying a first of the beams of laser energy to the quartz object, the first beam having a first energy level;
combining a second of the beams of laser energy with the first beam to form a composite beam, the second beam having a second energy level that is different than the first energy level; and
thermally processing the quartz object with the applied composite beam.

7. The method of claim 6, wherein the first beam has a first focal length and the second beam has a second focal length that is different from the first focal length.

8. The method of claim 6, wherein the step of thermally processing further comprises selectively heating the quartz object with the composite beam.

9. A method for thermal processing a quartz object using a plurality of beams of laser energy, comprising the steps of:
applying a first of the beams of laser energy to the quartz object, the first beam having a focal characteristic at a first level;
combining a second of the beams of laser energy with the first beam to form a composite beam, the second beam having a second level of the focal characteristic, the first level being different from the second level; and
thermally processing the quartz object with the applied composite beam.

10. The method of claim 9, wherein the focal characteristic is focal length.

11. The method of claim 9, wherein the focal characteristic is energy distribution profile.

12. The method of claim 9, wherein the focal characteristic is beam geometry.

13. The method of claim 9, wherein the step of thermally processing further comprises selectively heating the quartz object with the composite beam.

14. A method for thermal processing a quartz object using a plurality of beams of laser energy, comprising the steps of:
generating a first of the beams of laser energy;
generating a second of the beams of laser energy, the second beam being characteristically different than the first beam;
providing the first beam and the second beam to a combiner to form a composite beam;
applying the composite beam from the combiner to a portion of the quartz object; and
thermally processing the portion of the quartz object with the composite beam by selectively heating the portion of the quartz object using energy from the composite beam.

15. The method of claim 14, wherein the step of generating the second beam further comprises generating the second beam having a different wavelength than the first beam.

16. The method of claim 14, wherein the step of generating the second beam further comprises generating the second beam having a different energy level than the first beam.

17. The method of claim 14, wherein the step of generating the second beam further comprises generating the second beam having different focal characteristics than the first beam.

18. The method of claim 17, wherein the different focal characteristics include focal length.

19. The method of claim 17, wherein the different focal characteristics include beam geometry.

20. The method of claim 17, wherein the different focal characteristics include energy distribution profile.

21. The method of claim 14 further comprising the step of adjusting the first beam to alter how the composite beam selectively heats the portion of the quartz object.

22. The method of claim 21 further comprising the step of adjusting the second beam to further alter how the composite beam selectively heats the portion of the quartz object.

23. An apparatus for thermal processing a quartz object using a plurality of beams of laser energy, comprising:
a first laser for providing a first of the beams of laser energy on a first output;
a second laser for providing a second of the beams of laser energy on a second output, the second beam being characteristically different than the first beam; and
a combiner coupled to the first output and the second output, the combiner being operative to combine the first beam and the second beam into a composite beam, which is provided to a portion of the quartz object.

24. The apparatus of claim 23, further comprising a plurality of lenses positioned to receive the composite beam and focus the first beam and the second beam within the composite beam.

25. The apparatus of claim 24, wherein the lenses are adjustable to enable selective adjustment of focal lengths of the first beam and the second beam.

26. The apparatus of claim 24, wherein the combiner further comprises:
a beam expander coupled to the first output and being operative to delay the first beam relative to the second beam; and
a reflector/combiner that receives the delayed first beam from the beam expander and receives the second beam from the second output before joining the delayed first beam with the second beam into the composite beam.
